(19) United States
(12) Patent Application Publication
(10) Pub. No.: US 2026/0293999 A1
(43) Pub. Date: Oct. 1, 2026

(54) Aerosol-Generating Device

(71) Applicant: JT International SA, Geneva (CH)

(72) Inventor: Franck Pourrat, Les Gras (FR)

(73) Assignee: JT International SA, Geneva (CH)

(21) Appl. No.: 19/479,604

(22) PCT Filed: May 3, 2024
(86) PCT No.: PCT/EP2024/062283

§ 371 Date: Oct. 29, 2025

(30) Foreign Application Priority Data
May 10, 2023 (EP) 23172579.7

(51) Int. Cl. A24F 40/53; A24F 40/20; A24F 40/465; A24F 40/49; A24F 40/51; A24F 40/65

(52) U.S. Cl. CPC A24F 40/53; A24F 40/465; A24F 40/49; A24F 40/51; A24F 40/20; A24F 40/65

(57) ABSTRACT

An aerosol-generating device comprises a removable panel or cover that incorporates at least one sensitive area and that fits over a main body of the device. The at least one sensitive area is useful for implementing an authentication process before the device is used by a user. The authentication process ensures that the user is authorized to use the device, otherwise device use in inhibited or a warning is issued. A closure detector senses whether the removable panel or cover is positioned on the main body. The device is configured so that the at least one sensitive area or a sensing circuit which is coupled to said at least one sensitive area is electrically supplied only if the closure detector senses that the removable panel or cover is positioned on the main body.

### BACKGROUND OF THE INVENTION

Aerosol-generating devices are designed for users thereof to inhale air that is loaded with aerosol.

But regulations may exist in some countries for preventing underaged persons from vaping using these devices. However, it is possible that a person uses the aerosol-generating device of someone else without authorization or consent of this latter. Therefore, hygiene issue may raise.

Considering this issue, there is a need to ensure that an aerosol-generating device that belongs to a person cannot be used by another one without consent or authorization of the device owner.

WO 2022/230348 A1 discloses an aerosol-generating device which detects an input operation performed by a user, and which is provided with control means that release a lock state of the device depending on the input operation meeting or not an operation condition set by the user.

Another object of the invention consists in allowing user authentication in a quick and efficient way for the user of the aerosol-generating device.

Still another object of the invention consists in integrating in an optimized manner within an aerosol-generating device components that are implemented for user authentication, including optimized integration of these components with others of the device, in particular with respect to unit cost issue.

### SUMMARY OF THE INVENTION

For meeting at least one of these objects or others, a first aspect of the present invention proposes a new aerosol-generating device which comprises a casing and a heater or induction coil arranged within the casing for heating an aerosol-precursor material during a use of the device by a user. The casing is provided with at least one sensitive area that is suitable for the user to key in an access sequence, and the device is configured to enable its use if the access sequence that is keyed in using the at least one sensitive area matches a memorized reference access sequence, and otherwise inhibit the use of the device or issue a warning.

For the invention, the access sequence may be a code, a pattern, a touch sequence, etc., and any combination thereof, without limitation. Preferably but not necessarily, the at least one sensitive area may be comprised of a plurality of sensitive areas that are arranged in a matrix array, for example a 3×3 or 4×4 array.

According to a first invention feature, the casing comprises a removable panel or cover that incorporates the at least one sensitive area and that fits a main body of the device. Thanks to this feature, the at least one sensitive area can be customized by selecting the removable panel or cover as desired.

According to a second invention feature, the device further comprises a closure detector suitable for sensing whether the removable panel or cover is positioned on the main body. Then, the device is configured so that the at least one sensitive area or a sensing circuit which is coupled to this at least one sensitive area is electrically supplied if the closure detector senses that the removable panel or cover is positioned on the main body, and further configured so that electrical supply to the least one sensitive area or to the sensing circuit coupled thereto is inhibited otherwise. In this way, energy consumption due to the sensitive area or the sensing circuit is prevented when the removable panel or cover is not positioned on the main body. Use time of the device before next battery recharge is thus saved.

For example, the closure detector may be a Hall sensor or any contact sensor, e.g. electrical or mechanical contact sensor, without limitation.

In preferred embodiments, the at least one sensitive area may be formed from a flexible printed circuit, and the removable panel or cover comprises a membrane that covers the flexible printed circuit with respect to an outside of the casing. Then, the at least one sensitive area is functional through the membrane of the removable panel or cover. Such embodiments are cost-effective for production of the at least one sensitive area, and the membrane provides mechanical protection to the flexible printed circuit, thereby preventing it from being scratched and damaged during lifetime of the device.

Advantageously, the aerosol-generating device of the invention may further comprise at least one light generating system that is arranged in the casing so as to produce light information visible to the user of the device. Then the device may be configured so that the light information indicates a current status of the device, in particular during an authentication process that requires the access sequence to be keyed in using the at least one sensitive area or during an enrollment process dedicated to memorizing the reference access sequence. Such light information may be useful in helping the user when proceeding with the authentication process or the enrollment process. Preferably, such light generating system may comprise at least one light source which is integrated in the removable panel or cover and a driver circuit configured for controlling an operation of the at least one light source. Then, the driver circuit may also be integrated in the removable panel or cover. Both the light source and the driver circuit being integrated in the removable panel or cover leads to accurate control of the light source by the driver circuit. In particular, both may be mounted on the flexible printed circuit.

Alternatively, the at least one light source may be integrated in the removable panel or cover but the driver circuit which is configured for controlling the operation of the at least one light source may be integrated in the main body. This allows changing the removable panel or cover without requiring that another unit of driver circuit is provided at the same time. It leads to reduced cost of the removable panel or cover. The removal panel or cover can thus be provided as an accessory part which the user can replace in accordance with his preference by more reasonable price.

In first implementations, the at least one sensitive area may be of capacitive sensing area type. Then, the device may further comprise:
at least one sensor electrode that is dedicated respectively to each sensitive area;
a capacitance-to-digital converter which is electrically connected to each sensor electrode, and configured for outputting digital detection signals; and
a microcontroller unit, which is connected to the capacitance-to-digital converter for receiving the digital detection signals, and configured for controlling an operation of the device, including enabling the use of the device only if the access sequence that is keyed in using the at least one sensitive area matches the reference access sequence, this microcontroller unit being located in the main body.

Possibly, the capacitance-to-digital converter may be integrated in the removable panel or cover, and each sensor electrode may also be integrated in the removable panel or cover. Both the capacitance-to-digital converter and each sensor electrode being integrated in the removable panel or cover leads to accurate sensing by means of the sensor electrode. In particular, they may be all mounted on the flexible printed circuit.

Alternatively for the capacitive sensing area type, the capacitance-to-digital converter may be integrated in the main body, but each sensor electrode integrated again in the removable panel or cover. The removable panel or cover can thus be exchanged more easily, without necessity to provide a new capacitance-to-digital converter at the same time. It leads to reduced cost of the removable panel or cover.

Alternatively again for the capacitive sensing area type, the capacitance-to-digital converter together with each sensor electrode may be integrated in the main body. The removable panel or cover can thus be cheap and exchanged easily.

In second implementations, the at least one sensitive area may be of light-sensing area type. Then, the device may further comprise:
at least one photodetector that is dedicated respectively to each sensitive area, and arranged for detecting a light change due to the user touching this sensitive area;
at least one amplifier which is electrically connected to each photodetector, and adapted for outputting amplified detection signals; and
a microcontroller unit, which is connected to each amplifier for receiving the amplified detection signals, and configured for controlling an operation of the device, including enabling the use of the device only if the access sequence that is keyed in using the at least one sensitive area matches the reference access sequence, this microcontroller unit being located in the main body.

Possibly, each photodetector and each amplifier may be integrated in the removable panel or cover. The photodetector(s) and amplifier(s) being integrated in the removable panel or cover leads to accurate sensing by means of the photodector(s). In particular, they may be all mounted on the flexible printed circuit.

Alternatively for the light-sensing area type, each photodetector and each amplifier may be integrated in the main body. The removable panel or cover can thus be cheap and exchanged easily. In such case, the removable panel or cover may comprise at least one light-transmission path that is transparent so that the light change that is due to the user touching the sensitive area is transmitted by the light-transmission path to the corresponding photodetector.

In particular, each photodetector may comprise a photodiode.

In embodiments that use light-sensing area type and comprise at least one light generating system for producing light information, a light source may be common to a role of lighting the at least one sensitive area for making it functional, and to the at least one light generating system that is arranged to produce the light information.

In third embodiments, the at least one sensitive area may be of ultrasonic sensing area type. Then, the device may further comprise:
at least one ultrasonic transducer that is dedicated respectively to each sensitive area;
at least one ultrasonic sensor circuit which is electrically connected to each ultrasonic transducer, and configured for outputting detection signals; and
a microcontroller unit, which is connected to each ultrasonic sensor circuit for receiving the detection signals, and configured for controlling an operation of the device, including enabling the use of the device only if the access sequence that is keyed in using the at least one sensitive area matches the reference access sequence, this microcontroller unit being located in the main body.

Possibly, each ultrasonic sensor circuit may be integrated in the removable panel or cover, together with each ultrasonic transducer. The ultrasonic sensor circuit(s) and ultrasonic transducer(s) being all integrated in the removable panel or cover leads to manufacturing cost savings. In particular, they may be all mounted on the flexible printed circuit.

Alternatively for the ultrasonic sensing area type, each ultrasonic sensor circuit may be integrated in the main body, but each ultrasonic transducer integrated again in the removable panel or cover. The removable panel or cover can thus be exchanged more easily, without necessity to provide new ultrasonic sensor circuit at the same time.

Alternatively again for the ultrasonic sensing area type, each ultrasonic sensor circuit and also each ultrasonic transducer may be integrated in the main body. The removable panel or cover can thus be cheap and exchanged easily. Generally for the invention, the aerosol-generating device may comprise an inertial measurement unit. In such case, the device may be configured to produce an authentication-request signal which indicates that keying-in of the access sequence using the at least one sensitive area is requested, after the inertial measurement unit has detected a movement of the device. Such authentication-request signal may be a light signal or a vibration signal, without limitation.

Again generally for the invention, the aerosol-generating device may further comprise low-range wireless communication means, and be further configured to implement an additional authentication process using communication between the device and a terminal which is external to this device and wirelessly connected to it. Such additional authentication process may provide double authentication of the user with respect to the access sequence keyed-in at the device, thereby increasing authentication reliability. Then, the aerosol-generating device may be further configured to execute at least one of the following actions upon receiving instructions from the terminal through the low-range wireless communication means:
memorizing within the device a reference access sequence that is received from the terminal through the low-range wireless communication means; and
unlocking the device after this device has been locked due to a number of access sequence keying-in actions not matching the reference access sequence.

### BRIEF DESCRIPTION OF THE DRAWINGS

FIG. 1a illustrates an aerosol-generating device that implements the invention;

FIGS. 1b and 1c illustrate a removable panel and a main body, respectively, of the aerosol-generating device of FIG. 1a;

FIGS. 2a to 2c illustrate first embodiments in which sensitive areas are of capacitive sensing area type;

FIGS. 3a to 3c illustrate second embodiments in which sensitive areas are of light-sensing area type;

FIGS. 4a to 4c illustrate third embodiments in which sensitive areas are of ultrasonic sensing area type; and

FIG. 5 illustrates an optional improvement of the invention.

For clarity sake, element sizes which appear in these figures do not correspond to actual dimensions or dimension ratios. Also, same reference numbers which are indicated in different ones of these figures denote identical elements of elements with identical function.

### DETAILED DESCRIPTION OF THE INVENTION

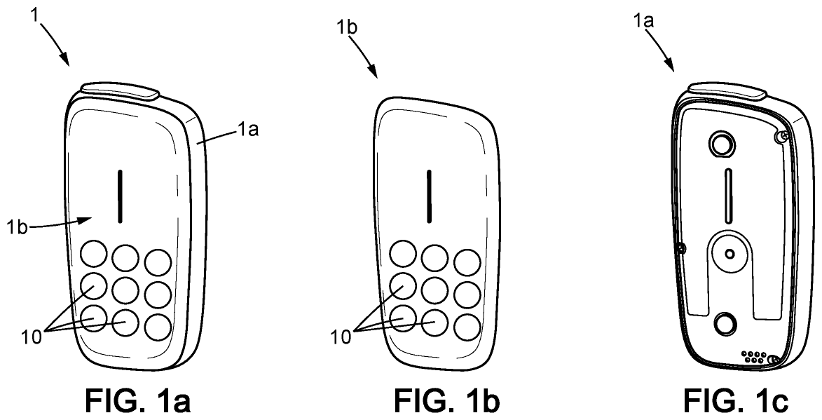

Referring to FIGS. 1a-1c, an aerosol-generating device 1 comprises a main body 1a and a removable panel 1b. The removable panel 1b can be positioned and clipped onto a front face of the main body 1a. The main body 1a contains components that provide operation of the aerosol-generating device 1, including a heating chamber for accommodating a stick which contains an amount of aerosol-precursor material, a heater, electrical circuitry, etc. The removable panel 1b is thus part of a casing of the device 1, but it may be exchanged for another one of a different model, for example of a different colour, which also fits the main body 1a, for customization by the owner of the device 1. According to the invention, the removable panel 1b is provided with at least one sensitive area 10, for example a 3×3 matrix array of nine sensitive areas 10. These sensitive areas 10 are useful for implementing an authentication process that prevents persons who are not authorized by the owner of the aerosol-generating device 1 from using this device. Typically, the authentication process may comprise requesting by the device 1 to key in an access code or pattern, then keying-in a code or pattern by the user by means of the sensitive areas 10, then comparing by the device 1 the code or pattern that has been keyed-in with a memorized reference access code or pattern, and unlocking the device 1 only if the code or pattern that has been keyed matches the memorized reference one. Preventing the user from using the device 1 when such user authentication has failed may consist in blocking power supply to the heater internally to the device 1, for example.

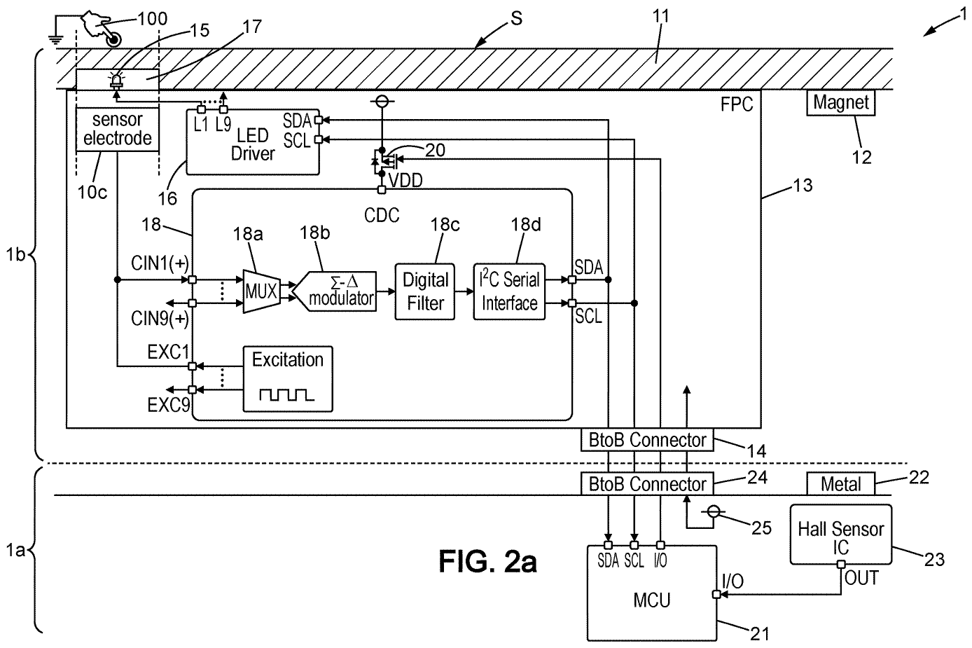

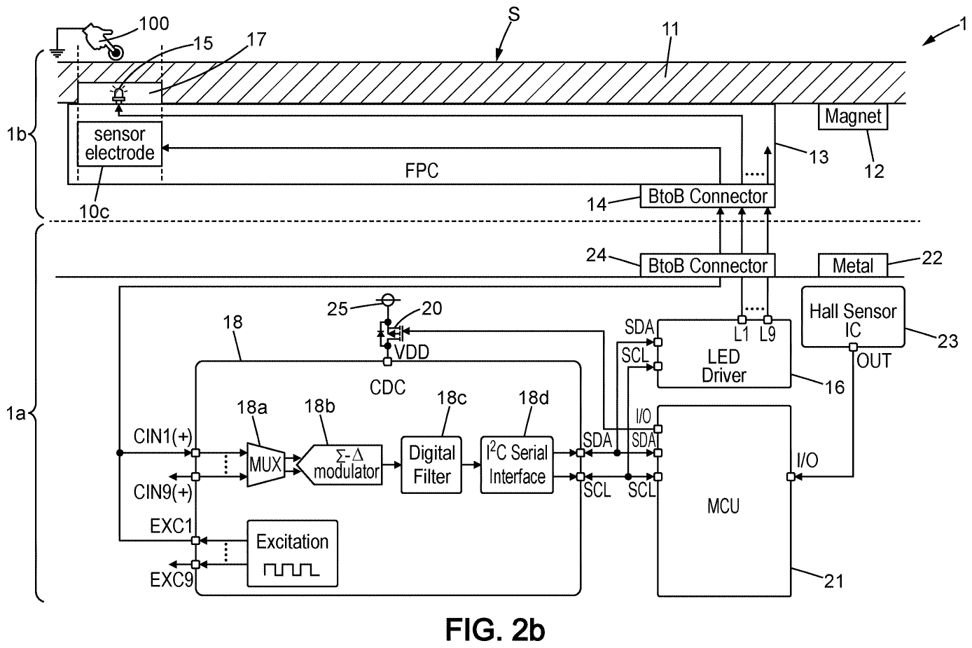

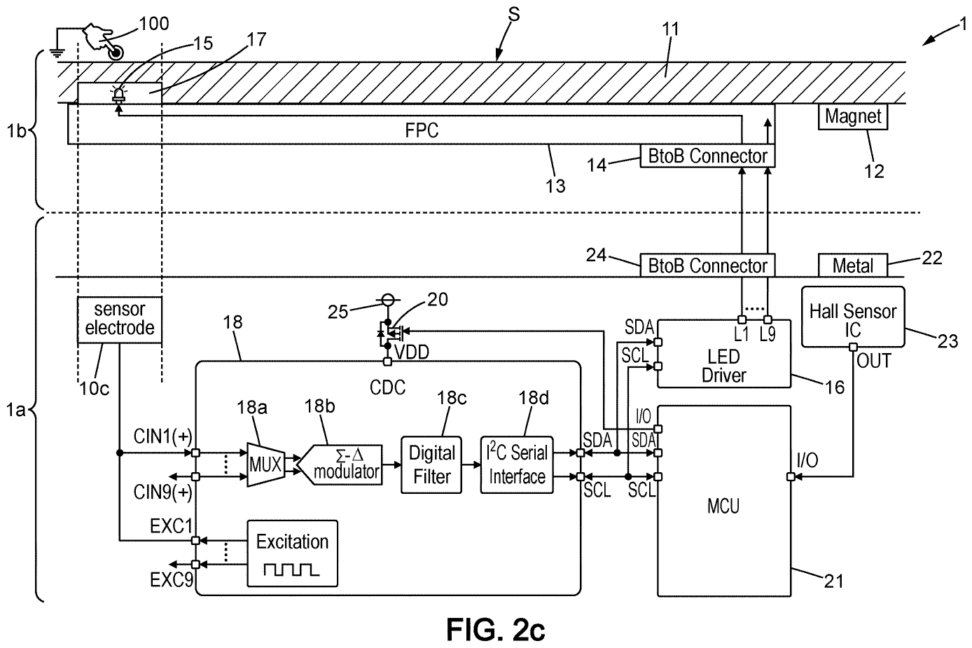

According to FIG. 2a or any one of the next figures, the removable panel 1b may comprise a membrane 11, for example of plastic material, that forms an outer surface S of the removable panel 1b, a magnet 12, a flexible printed circuit 13 noted FPC and a first electrical connector element 14. The magnet 12, the flexible printed circuit 13 and the first electrical connector element 14 may be fixedly fastened to the inner surface of the removable panel 1b so as to face the main body 1a internally to the device 1 when the removable panel 1b is fitted over the main body 1a. The first electrical connector element 14 is noted BtoB Connector in the figures, because it may be of a model designed for connecting two circuit boards. As described below, the flexible printed circuit 13 is dedicated to forming electrical connections and possibly also supporting components that are dedicated to the sensitive areas 10. The first electrical connector element 14 is permanently connected to electrical tracks of the flexible printed circuit 13 for transmitting power supply from the main body 1a, transferring sensing signals from components located on the removable panel 1b to the main body 1a, and/or conveying control signals between the components located on the removable panel 1b and the main body 1a. The magnet 12 is part of a closure detector arranged at the main body 1a. In addition, the membrane 11 is thin enough for the sensing components that form the sensitive areas 10 to be functional through this membrane.

The main body 1a is provided with a microcontroller unit 21, noted MCU, a metal element 22, a Hall sensor 23 and a second electrical connector element 24. When the removable panel 1b is fitted over the main body 1a, the magnet 12 gets into contact with the metal element 22, and this contact is detected by the Hall sensor 23, thereby providing closure detector operation. Simultaneously, the first and second electrical connector elements 14 and 24 couple to each other, so that electrical connections from the flexible printed circuit 13 are extended to the microcontroller unit 21 and other electrical components located within the main body 1a. When the removable panel 1b is fitted over the main body 1a, the Hall sensor 23 transmits a positive closure detection signal to the microcontroller unit 21, and this latter is configured to activate the sensitive areas 10 once it has received such positive closure detection signal. Activating the sensitive areas 10 consists in allowing electrical power supply from the main body 1a to components supported by the flexible printed circuit 13. Conversely, when the removable panel 1b is not fitted properly over the main body 1a, the Hall sensor 23 transmits a negative closure detection signal to the microcontroller unit 21, and this latter is configured to inhibit the sensitive areas 10 when it receives such negative closure detection signal. Inhibiting the sensitive areas 10 consists in blocking electrical power supply from the main body 1a to components supported by the flexible printed circuit 13. Positive and negative of the closure detection signal may be changed. It this alternative embodiment, positive closure detection signal means that the removable panel 1b is not fitted properly over the main body 1a, and negative closure detection signal means that the removable panel 1b is fitted over the main body 1a.

The aerosol-generating device 1 is preferably further provided with at least one light generating system that is arranged in the casing of the device for delivering light information to the device user. Preferably, at least part of such light generating system may be arranged in the removable panel 1b. It may comprise at least one light source 15, for example of LED-type, a light source driver circuit 16, noted LED Driver in the figures, and possibly at least one light guide 17 arranged in the membrane 11 for delivering the light information at desired location in the outer surface S of the removable panel 1b. The light source driver circuit 16 may be provided as an integrated circuit. This light generating system forms a user interface which is dedicated to inform the device user about a current status of the device, in particular about aerosol availability for vaping, and during the authentication process or during an enrollment process dedicated to memorizing the reference access code or pattern. Each light source 15 is preferably arranged in the removable panel 1b, on the flexible printed circuit 13. The light source driver circuit 16 may be arranged on the flexible printed circuit 13 too, and connected for being controlled by the microcontroller unit 21 and power-supplied through the electrical connector elements 14 and 24. Alternatively, the light source driver circuit 16 may be arranged in the main body 1a, and connected to each light source 15 through the electrical connector elements 14 and 24. Possibly, nine light sources 15 may be provided and optically coupled to the nine sensitive areas 10 through appropriate light guides 17, for pointing the locations of the sensitive areas 10 in the outer surface S in a user-friendly manner.

FIGS. 2a-2c relate to embodiments of the invention where the sensitive areas are of capacitive sensing area type. Each sensitive area 10 then comprises a respective sensor electrode which is denoted using reference sign 10c. For such embodiments, the device 1 is provided with a capacitance-to-digital converter 18, which is noted CDC and electrically connected to each sensor electrode 10c. The capacitance-to-digital converter 18 may be provided as the integrated circuit. In a known manner, each sensor electrode 10c needs to be supplied with an excitation signal by the converter 18, and the converter 18 collects sensing signals from each sensor electrode 10c and converts these sensing signals into digital detection signals to be transmitted to the microcontroller unit 21. For performing this signal conversion, the converter 18 may contain the following chained components: a multiplexer 18a, noted MUX, for multiplexing the sensing signals which originate separately from all the sensor electrodes 10c, a Σ-Δ modulator 18b, a digital filter 18c and a serial communication interface 18 d, for example of I²C type, I²C standing for inter-integrated circuit interface. Operation of one of the sensitive areas 10 then consists in supplying the corresponding sensor electrode 10c with the excitation signal, and detecting by means of the converter 18 whether a user's finger 100 produces alteration of a current flowing back from the sensor electrode 10c of the same sensitive area 10. The converter 18 constitutes the sensing circuit in the meaning as used in the general description of the invention.

The converter 18 may be power-supplied from a power supply 25 in the main body 1a through a dedicated controlled switch 20. For example, the controlled switch 20 may be a MOSFET. A source terminal of the MOSFET 20 is then connected to a VDD-terminal of the converter 18, a drain terminal of the MOSFET 20 is to be connected to the power supply 25, and a gate terminal of the MOSFET 20 is to be connected to a control output I/O of the microcontroller unit 21. Thus, it is possible to conditionally allow power supply to the converter 18 based on the closure detection signal issued by the Hall sensor 23, through appropriate configuration of the microcontroller unit 21.

FIG. 2a corresponds to such embodiment of the invention with capacitive type sensing areas where the sensor electrodes 10c and also the converter 18 are integrated in the removable panel 1b, on the flexible printed circuit 13. The light source driver circuit 16 and the MOSFET 20 are also integrated in the removable panel 1b, again on the flexible printed circuit 13.

FIG. 2b corresponds to another embodiment with capacitive type sensing areas, but the sensor electrodes 10c only are integrated in the removable panel 1b, on the flexible printed circuit 13. The converter 18, the light source driver circuit 16 and the MOSFET 20 are integrated in the main body 1a.

FIG. 2c corresponds to still another embodiment with capacitive type sensing areas, but where all the following components are integrated in the main body 1a: the sensor electrodes 10c, the converter 18, the light source driver circuit 16 and the MOSFET 20. In such embodiment, the function of the flexible printed circuit 13 is limited to electrically connecting each light source 15 to the first electrical connector element 14.

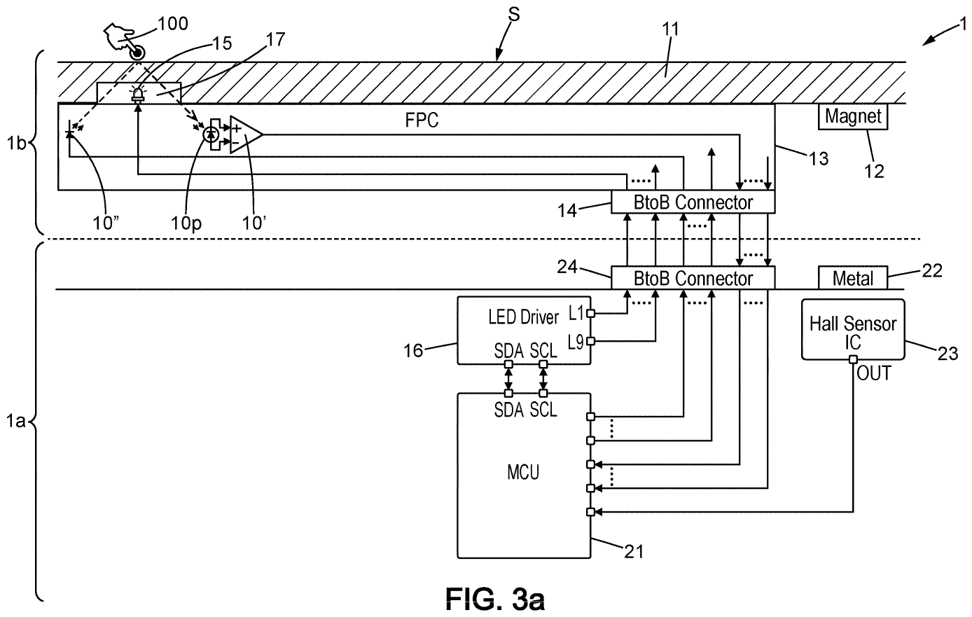

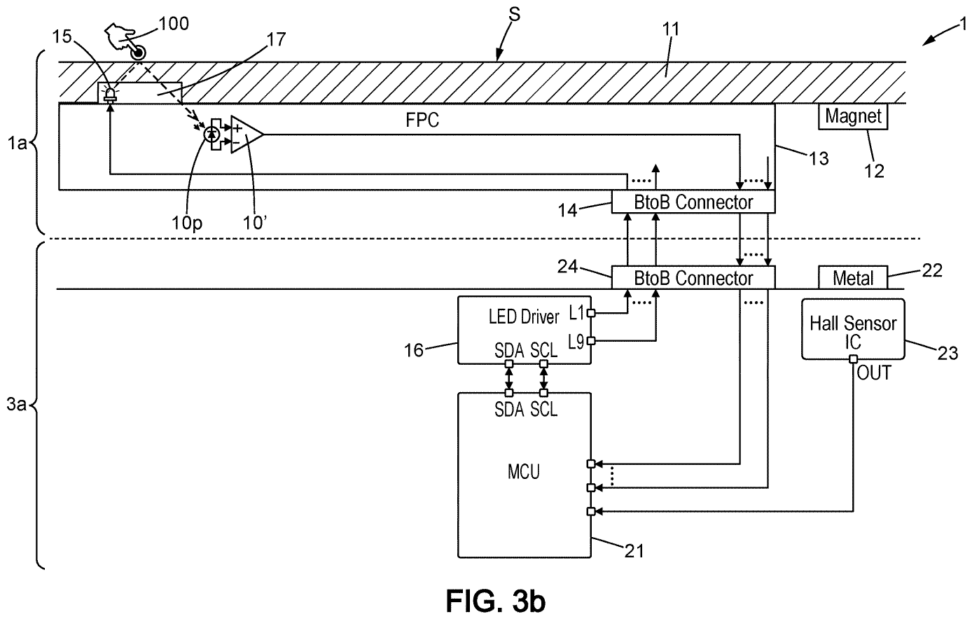

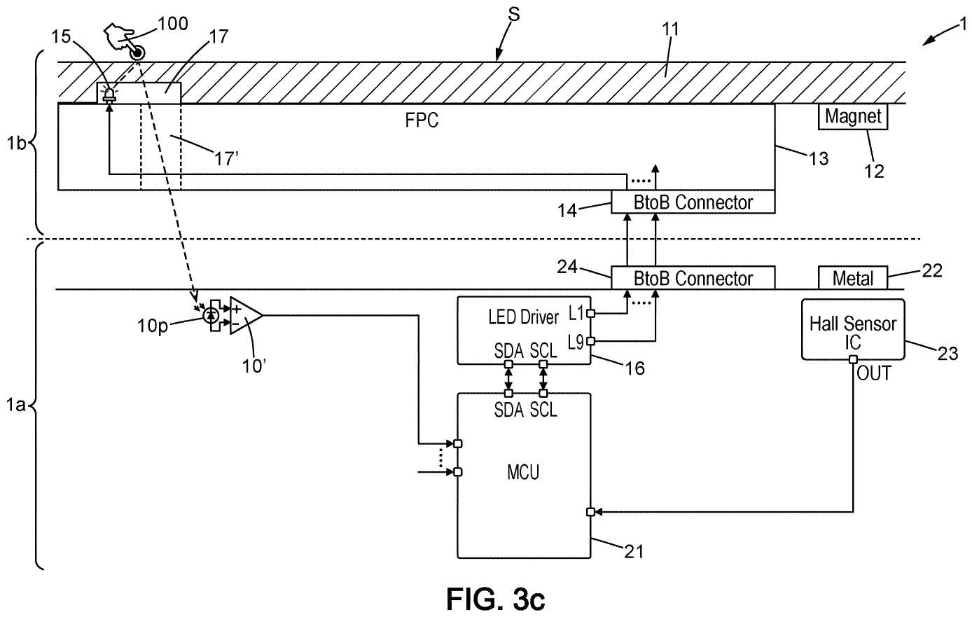

FIGS. 3a-3c relate to embodiments of the invention where the sensitive areas are of light-sensing area type. Each sensitive area 10 then comprises a respective photodetector which is denoted using reference sign 10p. Such photodetector 10p may be a photodiode, for example. It is connected to input terminals of a respective amplifier 10′ which outputs amplified detection signals to be transmitted to respective input terminals of the microcontroller unit 21. The amplifiers 10′ constitute all together the at least one sensing circuit in the meaning as used in the general description of the invention. The microcontroller unit 21 may also have output control terminals that are connected respectively to additional light sources 10″ which are dedicated one-to-one to the photodetectors 10p. Operation of one of the sensitive areas 10 then consists in activating the corresponding additional light source 10″ for light emission, and detecting whether a user's finger 100 produces reflection of some of the light produced by this additional light source 10″ to the photodetector 10p of the same sensitive area 10. In such embodiments, blocking of the electrical power supply to the amplifiers 10′ can be controlled by the microcontroller unit 21 in a way similar to that described above for the converter 18.

FIG. 3a corresponds to such embodiment of the invention with light-sensing area type, where the photodetectors 10p, the amplifiers 10′ and the additional light sources 10″ are integrated in the removable panel 1b, on the flexible printed circuit 13. The light source driver circuit 16 is integrated in the in the main body 1a.

FIG. 3b corresponds to another embodiment of the invention with light-sensing area type, where each additional light source 10″ is suppressed and replaced by one of the light sources 15 for operation of the corresponding sensitive area 10. In this embodiment, the photodetectors 10p, the amplifiers 10′ and the light sources 15 are all integrated again in the removable panel 1b. The light source driver circuit 16 is integrated in the main body 1a again.

FIG. 3c corresponds to still another embodiment of the invention with light-sensing area type, which is derived from that of FIG. 3b but the photodetectors 10p and the amplifiers 10′ have been moved from the removable panel 1b to the main body 1a. The function of the flexible printed circuit 13 is thus limited again to electrically connecting each light source 15 to the first electrical connector element 14. For such arrangement where the light sources 15 and the photodetectors 10p are on opposite sides of the flexible printed circuit 13, light transmission paths 17′ are provided through the flexible printed circuit 13. The light transmission paths 17′ are transparent to the light produced by the light sources 15. For each sensitive area 10, the respective light source 15 and transmission path 17′ are arranged so that at least part of the light which is produced by the light source 15 and reflected by the user's finger 100 touching the sensitive area is transmitted to the corresponding photodetector 10p.

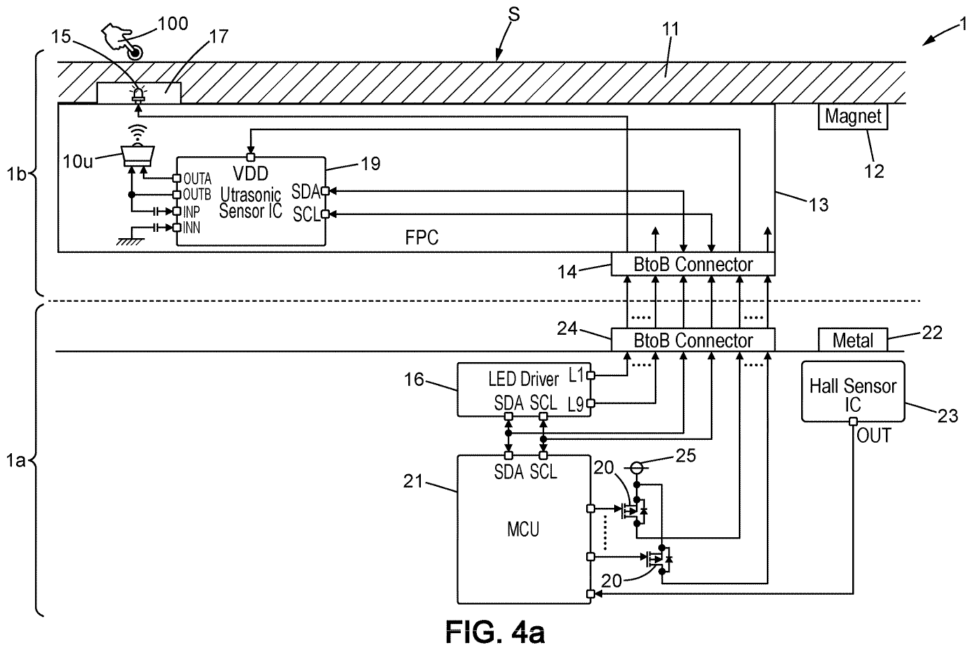

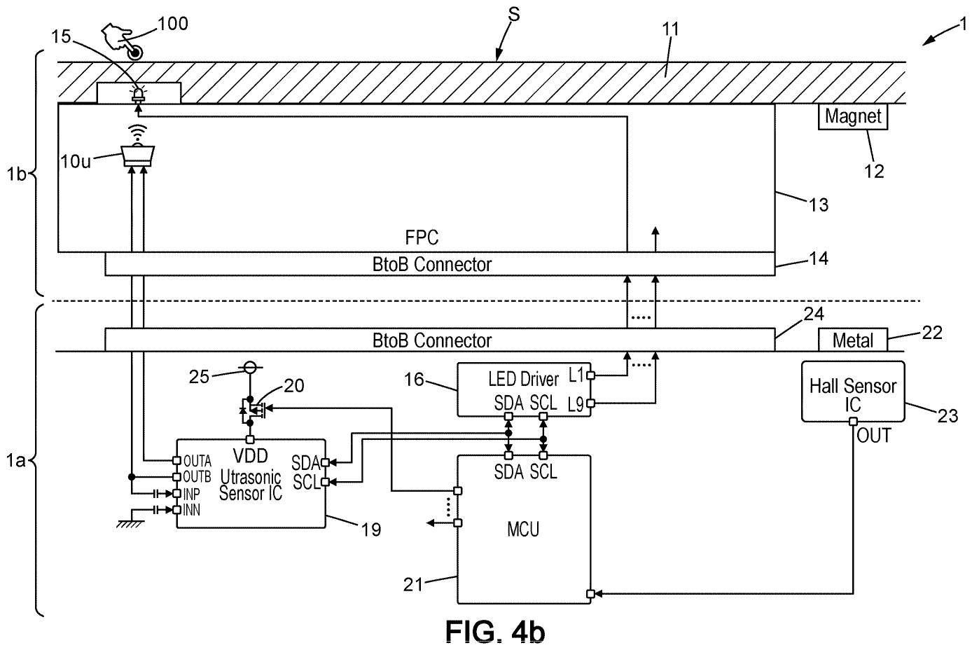

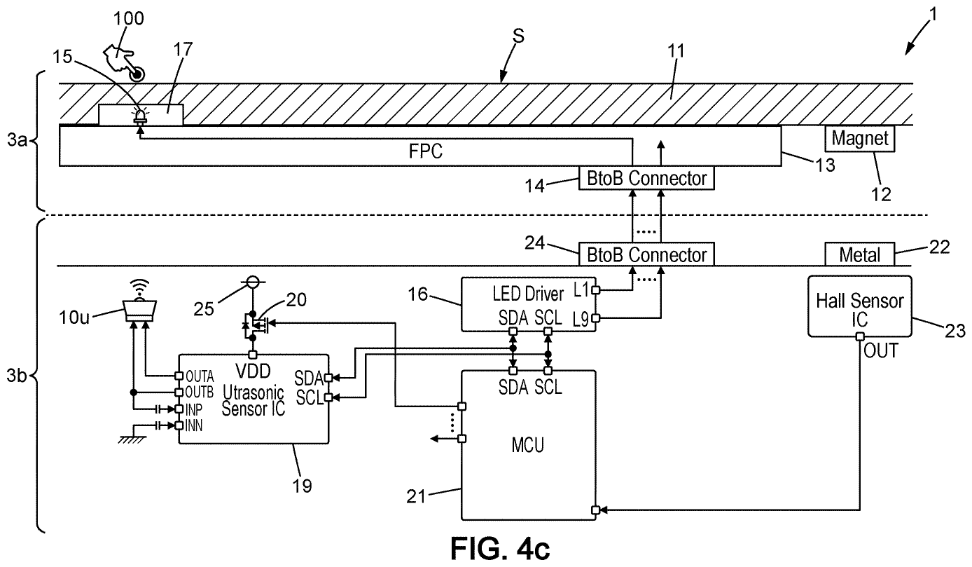

FIGS. 4a-4c relate to embodiments of the invention where the sensitive areas are of ultrasonic sensing area type. Each sensitive area 10 then comprises a respective ultrasonic transducer which is denoted using reference sign 10u, and a respective ultrasonic sensor integrated circuit 19. For each sensitive area 10, the ultrasonic sensor integrated circuit 19 is electrically connected to the ultrasonic transducer 10u in an appropriate manner for allowing controlled operation of this latter. Operation of one of the sensitive areas 10 then consists in supplying the corresponding ultrasonic transducer 10u with a source signal from the corresponding ultrasonic sensor integrated circuit 19, producing an ultrasonic emission by the ultrasonic transducer 10u towards the outer surface S, and detecting by means of the ultrasonic transducer 10u and circuit 19 whether the user's finger 100 produces alteration of an ultrasonic wave reflected back from the outer surface S in the sensitive area considered. The circuit 19 thus outputs a detection signal which is transmitted to the microcontroller unit 21. Each ultrasonic sensor integrated circuit 19 constitutes the sensing circuit in the meaning as used in the general description of the invention.

FIG. 4a corresponds to such embodiment of the invention with ultrasonic sensing area type, where the ultrasonic transducers 10u and also the ultrasonic sensor integrated circuits 19 are integrated in the removable panel 1b, on the flexible printed circuit 13. The light source driver circuit 16 is integrated in the main body 1a. FIG. 4a also shows that electrical power supply to each of the ultrasonic sensor integrated circuits 19 is controlled by a respective MOSFET 20, again in a manner similar to that explained above with reference to FIGS. 2a-2c. In the embodiment of FIG. 4a, the MOSFETs 20 are all integrated in the main body 1a.

FIG. 4b corresponds to another embodiment of the invention with ultrasonic sensing area type, where only the ultrasonic transducers 10u are integrated in the removable panel 1b, on the flexible printed circuit 13, but the ultrasonic sensor integrated circuits 19 are integrated in the main body 1a. The light source driver circuit 16 and the MOSFETs 20 are integrated in the main body 1a again.

FIG. 4c corresponds to still another embodiment of the invention with ultrasonic sensing area type, where all the following components are integrated in the main body 1a: the ultrasonic transducers 10u, the ultrasonic sensor integrated circuits 19, the light source driver circuit 16 and the MOSFETs 20. In such embodiment, the function of the flexible printed circuit 13 is only electrically connecting each light source 15 to the first electrical connector element 14.

Although the above-described embodiments relate to three different types of sensitive areas, still other types may be implemented in combination with the invention. For example, other embodiments of the invention may use resistive sensitive areas.

In all the above-described embodiments, the microcontroller unit 21 is integrated in the main body 1a. In addition to controlling the operation of the aerosol-generating device 1 for delivering aerosol to the user and controlling electrical power supply to each sensitive area and/or sensing circuit based on the closure detection signal, the microcontroller unit 21 may have the functions of implementing user authentication and allowing or blocking device use based on a result of the authentication process. For example, the device 1 may be provided with an inertial measurement unit (not shown), and may be configured to trigger a new authentication process each time the inertial measurement unit detects movement after a rest period of predetermined duration. At this time, use of the device 1 is prevented by the microcontroller unit 21, for example by blocking power supply to the heater. The authentication process may start with activating the light source(s) 15 for emitting a light signal visible to the user, this light signal meaning that an authentication code or pattern is expected to be keyed in. If no authentication code or pattern is keyed in by the user by means of the sensing areas 10, or if the code or pattern that is keyed in by the user does not match a reference access code or pattern that has been previously memorized, blocking of the power supply to the heater is maintained. This power supply to the heater is restored only if the authentication code or pattern that has been keyed in by the user by means of the sensing areas 10 matches the previously memorized reference access code or pattern, thereby allowing use of the device. The device 1 may be locked for a predetermined prevention duration, for example three hours, after a predetermined number, for example three, of wrong authentication codes or patterns have been keyed in as successive authentication attempts. Unlocking of the device 1 may be automatic at the end of the predetermined prevention duration, or may be triggered another way, for example using an external communication device which is connected to the aerosol-generating device 1.

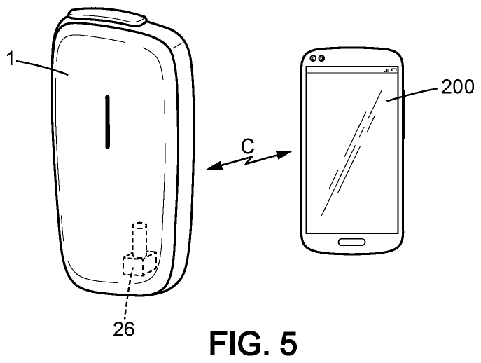

Indeed, it may be advantageous that the aerosol-generating device 1 is provided with low-range wireless communication means, as shown in FIG. 5 with reference number 26. These communication means 26 are suitable for connection to an external terminal 200. Reference letter C indicates the radio link between the aerosol-generating device 1 and the external terminal 200, this radio link possibly being of Bluetooth® type as an example. The external terminal 200 may be a smartphone which is loaded with an application dedicated for controlling use of the aerosol-generating device 1. Thus, the external terminal can execute the following functions:
triggering unlocking of the aerosol-generating device 1 after a plurality of successive failed authentication attempts have been executed with the sensitive areas 10 of the device 1;
inputting and memorizing the reference access code or pattern through an enrollment process, and then transmitting this memorized reference access code or pattern to the aerosol-generating device 1, for implementation in the executions of the authentication process by the device 1; and
allowing to proceed with a double authentication process, by the user keying in the access code or pattern with the sensitive areas 10 at the aerosol-generating device 1, but by checking additionally that this user can access simultaneously to the external terminal 200. Such check that the user of the aerosol-generating device 1 can access to the external terminal 200 constitutes an additional authentication process. It increases authentication reliability compared to only keying the access code or pattern in the device 1.

Finally, it is indicated that blocking the device use upon successive failed authentication attempts may be replaced by transmitting a warning signal to the user. Such warning signal may be issued by the light generating system of the device, for example by producing red flashing light.

1. An aerosol-generating device comprising:
a heater or induction coil arranged within the casing for heating an aerosol-precursor material during a use of the device by a user,
at least one sensitive area configured to receive an access sequence;
a casing, the casing comprising a removable panel or cover that incorporates the at least one sensitive area and that fits a main body of the device; and
a closure detector configured to sense whether the removable panel or cover is positioned on the main body,
wherein the device is configured to enable the use of said device if the access sequence matches a stored reference access sequence, and otherwise inhibit the use of the device or issue a warning, and
wherein the device is configured so that:
the at least one sensitive area or a sensing circuit coupled to said at least one sensitive area is electrically supplied if the closure detector senses that the removable panel or cover is positioned on the main body, and
electrical supply to the least one sensitive area or to the sensing circuit coupled thereto is inhibited if said closure detector does not sense that said removable panel or cover is positioned on said main body.

2. The aerosol-generating device of claim 1, wherein the at least one sensitive area is formed from a flexible printed circuit, and the removable panel or cover comprises a membrane that covers the flexible printed circuit with respect to an outside of the casing, said at least one sensitive area being functional through the membrane of the removable panel or cover.

3. The aerosol-generating device of claim 1, further comprising at least one light generating system that is arranged in the casing so as to produce light information visible to the user of the device, the device being configured so that said light information indicates a current status of the device, during an authentication process that requires the access sequence to be received by the at least one sensitive area or during an enrollment process dedicated to storing the reference access sequence.

4. The aerosol-generating device of claim 3, wherein the at least one light generating system comprises at least one light source integrated in the removable panel or cover and a driver circuit configured for controlling an operation of the at least one light source, wherein the driver circuit is integrated in the removable panel or cover.

5. The aerosol-generating device of claim 3, wherein the at least one light generating system comprises at least one light source integrated in the removable panel or cover and a driver circuit configured for controlling an operation of the at least one light source, wherein the driver circuit is integrated in the main body.

6. The aerosol-generating device of claim 1, wherein the at least one sensitive area is a capacitive sensing area and the device further comprises:
at least one sensor electrode dedicated respectively to each sensitive area;
a capacitance-to-digital converter electrically connected to each sensor electrode, and configured for outputting digital detection signals; and
a microcontroller unit, connected to the capacitance-to-digital converter for receiving the digital detection signals, and configured for controlling an operation of the device including enabling the use of said device only if the access sequence that is received by the at least one sensitive area matches the reference access sequence, said microcontroller unit being located in the main body,
wherein the capacitance-to-digital converter is integrated in the removable panel or cover, and wherein each sensor electrode is integrated in the removable panel or cover.

7. The aerosol-generating device of claim 1, wherein the at least one sensitive area is a capacitive sensing area, and the device further comprises:
at least one sensor electrode dedicated respectively to each sensitive area;
a capacitance-to-digital converter electrically connected to each sensor electrode and configured for outputting digital detection signals; and
a microcontroller unit, connected to the capacitance-to-digital converter for receiving the digital detection signals, and configured for controlling an operation of the device, including enabling the use of said device only if the access sequence that is received by the at least one sensitive area matches the reference access sequence, said microcontroller unit being located in the main body,
wherein the capacitance-to-digital converter is integrated in the main body, and wherein each sensor electrode is integrated in the removable panel or cover.

8. The aerosol-generating device of claim 1, wherein the at least one sensitive area is a capacitive sensing area, and the device further comprises:
at least one sensor electrode dedicated respectively to each sensitive area;
a capacitance-to-digital converter electrically connected to each sensor electrode, and configured for outputting digital detection signals; and
a microcontroller unit, connected to the capacitance-to-digital converter for receiving the digital detection signals, and configured for controlling an operation of the device, including enabling the use of said device only if the access sequence that is received by the at least one sensitive area matches the reference access sequence, said microcontroller unit being located in the main body,
wherein the capacitance-to-digital converter is integrated in the main body, and wherein each sensor electrode is integrated in the main body.

9. The aerosol-generating device of claim 1, wherein the at least one sensitive area is a light-sensing area, and the device further comprises:
at least one photodetector dedicated respectively to each sensitive area, and arranged for detecting a light change due to the user touching said sensitive area;
at least one amplifier electrically connected to each photodetector, and adapted for outputting amplified detection signals; and
a microcontroller unit, connected to each amplifier for receiving the amplified detection signals, and configured for controlling an operation of the device, including enabling the use of said device only if the access sequence that is received by the at least one sensitive area matches the reference access sequence, said microcontroller unit being located in the main body,
wherein each photodetector and each amplifier are integrated in the removable panel or cover.

10. The aerosol-generating device of claim 1, wherein the at least one sensitive area is a light-sensing area, and the device further comprises:
at least one photodetector dedicated respectively to each sensitive area, and arranged for detecting a light change due to the user touching said sensitive area;
at least one amplifier electrically connected to each photodetector, and adapted for outputting amplified detection signals; and
a microcontroller unit, connected to each amplifier for receiving the amplified detection signals, and configured for controlling an operation of the device, including enabling the use of said device only if the access sequence that is received by the at least one sensitive area matches the reference access sequence, said microcontroller unit being located in the main body,
wherein each photodetector and each amplifier are integrated in the main body, and
wherein the removable panel or cover comprises a light-transmission path that is transparent so that the light change that is due to the user touching the sensitive area is transmitted by the light-transmission path to the corresponding photodetector.

11. The aerosol-generating device of claim 4, wherein a light source is common to a role of lighting the at least one sensitive area for making said sensitive area functional, and to the at least one light generating system that is arranged to produce the light information.

12. The aerosol-generating device of claim 1, wherein the at least one sensitive area is of an ultrasonic sensing area and the device further comprises:
at least one ultrasonic transducer dedicated respectively to each sensitive area;
at least one ultrasonic sensor circuit electrically connected to each ultrasonic transducer and configured for outputting detection signals; and
a microcontroller unit, connected to each ultrasonic sensor circuit for receiving the detection signals, and configured for controlling an operation of the device, including enabling the use of said device only if the access sequence that is received by the at least one sensitive area matches the reference access sequence, said microcontroller unit being located in the main body,
wherein the at least one ultrasonic sensor circuit is integrated in the removable panel or cover, and wherein each ultrasonic transducer is integrated in the removable panel or cover.

13. The aerosol-generating device of claim 1, wherein the at least one sensitive area is an ultrasonic sensing area, and the device further comprises:
at least one ultrasonic transducer dedicated respectively to each sensitive area;
at least one ultrasonic sensor circuit electrically connected to each ultrasonic transducer and configured for outputting detection signals; and
a microcontroller unit, connected to each ultrasonic sensor circuit for receiving the detection signals, and configured for controlling an operation of the device, including enabling the use of said device only if the access sequence that is received by the at least one sensitive area matches the reference access sequence, said microcontroller unit being located in the main body,
wherein each ultrasonic sensor circuit is integrated in the main body, and wherein each ultrasonic transducer is integrated in the removable panel or cover.

14. The aerosol-generating device of claim 1, wherein the at least one sensitive area is an ultrasonic sensing area, and the device further comprises:
at least one ultrasonic transducer dedicated respectively to each sensitive area;
at least one ultrasonic sensor circuit electrically connected to each ultrasonic transducer and configured for outputting detection signals; and
a microcontroller unit, connected to each ultrasonic sensor circuit for receiving the detection signals, and configured for controlling an operation of the device including enabling the use of said device only if the access sequence that is received by the at least one sensitive area matches the reference access sequence, said microcontroller unit being located in the main body,
wherein each ultrasonic sensor circuit is integrated in the main body, and each ultrasonic transducer is integrated in the main body.

15. The aerosol-generating device of one of claim 1, further comprising low-range wireless communication device, and further configured to implement an additional authentication process using communication between the device and a terminal which is external to said device and wirelessly connected to said device,
wherein the device is further configured to execute at least one of the following actions upon receiving instructions from the terminal through the low-range wireless communication device;
storing, within the device, a reference access sequence that is received from the terminal through the low-range wireless communication device; and
unlocking the device after said device has been locked due to a number of received access sequences not matching the reference access sequence.

16. The aerosol-generating device of claim 5, wherein a light source is common to a role of lighting the at least one sensitive area for making said sensitive area functional, and to the at least one light generating system that is arranged to produce the light information.

17. The aerosol-generating device of claim 9, wherein a light source is common to a role of lighting the at least one sensitive area for making said sensitive area functional, and to the at least one light generating system that is arranged to produce the light information.

18. The aerosol-generating device of claim 10, wherein a light source is common to a role of lighting the at least one sensitive area for making said sensitive area functional, and to the at least one light generating system that is arranged to produce the light information.
